(19) United States
(12) Patent Application Publication
(10) Pub. No.: US 2026/0257327 A1
(43) Pub. Date: Sep. 3, 2026

(54) HIGH-STRENGTH LITHIUM BATTERY NAIL GUN WITH COMPOSITE ENERGY STORAGE STRUCTURE

(71) Applicant: TAIZHOU TUBA MACHINERY CO., LTD, Taizhou, Zhejiang (CN)

(72) Inventors: WENWEI ZHANG, TAIZHOU (CN); RIFU ZHENG, TAIZHOU (CN)

(21) Appl. No.: 18/995,721

(22) PCT Filed: Jul. 16, 2024
(86) PCT No.: PCT/CN2024/105597

§ 371 Date: Jan. 16, 2025

(30) Foreign Application Priority Data
Jul. 17, 2023 (CN) 202310872784.6

(51) Int. Cl. B25C 1/06; B25C 1/04; H01M 10/052; H02J 15/30

(52) U.S. Cl. CPC B25C 1/06; B25C 1/041; B25C 1/047; H01M 10/052; H02J 15/30; H01M 2220/30

(57) ABSTRACT

A high-strength lithium battery nail gun with a composite energy storage structure is provided, which includes a gun body (1) having a tail section provided with an energy storage structure. The energy storage structure includes a spring compressing mechanism (2) and a vacuum cylinder mechanism (3). The spring compressing mechanism (2) includes a compression cavity (21), a spring (22), a spring piston (23) and a working piston rod (24). The spring (22) and the spring piston (23) are mounted in the compression cavity (21). A front end of the spring piston (23) is connected to the working piston rod (24). The lower part of the working piston rod (24) is provided with an upper rack structure (241). The vacuum cylinder mechanism (3) includes a cylinder (31) and a cylinder piston (32). A completely sealed vacuum chamber (3a) is formed by the cylinder piston (32) and a tail end part of the cylinder (31). The upper side of the vacuum cylinder piston rod (33) is provided with a lower rack structure (331). The lower rack structure (331) is in engaged transmission with the upper rack structure (241) through a transmission gear (5). Through the energy storage structure, the spring compressing mechanism (2) and the vacuum cylinder mechanism (3) are organically combined into a whole body, so that the energy storage strength can be multipled, and the axial and radial vibration at the end of nailing can be effectively reduced.

### TECHNICAL FIELD

The present disclosure belongs to a field of a handheld lithium battery nail gun, and particularly relates to a high-strength lithium battery nail gun with a composite energy storage structure.

### BACKGROUND

The lithium battery nail gun is a handheld lithium battery nailing tool, and is mostly used in construction, decoration and furniture industries.

At present, the most widely used lithium battery nail gun drives the piston to compress the spring for energy storage through the motor, the speed reducer and the rotary transmission mechanism, and the nail is shot by releasing the compressed spring. In the above-mentioned structure, the efficiency of the transmission mechanism, the spring guiding resistance, the elasticity modulus of the spring, the weight of the rebound part and the rebound force of the spring affect the nailing force and operation comfort.

After years of use, it is found that the structure of the existing lithium battery nail gun has the following two main problems.

Firstly, the energy storage with the spring alone is subjected to the length and rigidity of the spring, resulting in insufficient energy storage strength obtained in the end. The needs of some high-strength nailing operations are difficult to meet.

Secondly, after nailing, the spring is affected by the impact counter-acting force, and the axial vibration is large, resulting in an increase in the rebound force. The operation comfort is influenced, and the fatigue strength of operators is increased.

### SUMMARY

Aiming at the above-mentioned problems, the present disclosure designs a high-strength lithium battery nail gun with a composite energy storage structure. The energy storage structure of the high-strength lithium battery nail gun organically combines spring compression and a cylinder mechanism into a whole body, so that the energy storage strength can be multipled, the problem of axial and radial vibration at the end of nailing can be effectively alleviated, and then the labor strength is reduced, and the comfort of nailing operation is improved.

In order to solve the-mentioned technical problems, the present disclosure adopts the following technical scheme.

A high-strength lithium battery nail gun with a composite energy storage structure, comprising a gun body having a tail section of the gun body provided with an energy storage structure, wherein the energy storage structure comprises a spring compressing mechanism and a vacuum cylinder mechanism linked with each other; wherein the spring compressing mechanism comprises a compression cavity, a spring, a spring piston and a working piston rod, the spring and the spring piston are mounted in the compression cavity, a tail end of the spring abuts against a bottom of the compression cavity, a front end of the spring abuts against the spring piston for connection, and the spring has a precompression amount in an initial state so that the spring piston always has a forward moving trend; a front end of the spring piston is connected to the working piston rod for driving a gun needle to work synchronously, and a lower part of the working piston rod is provided with an upper rack structure; the vacuum cylinder mechanism comprises a cylinder and a cylinder piston arranged in the cylinder, a completely sealed vacuum chamber is formed by the cylinder piston and a tail end part of the cylinder, the cylinder piston is located at a tail section of the cylinder in an initial state, a front end of the cylinder piston is connected to a vacuum cylinder piston rod extending out of the cylinder, an upper side of the vacuum cylinder piston rod is provided with a lower rack structure, and the lower rack structure is in engaged transmission with the upper rack structure through a transmission gear fixed on the gun body; and a front end of the vacuum cylinder piston rod is provided with a transmission structure to be in transmission connection with a driving mechanism.

More specifically, the lower rack structure is in engaged transmission with the upper rack structure through the transmission gear, and teeth of the lower rack structure, the upper rack structure and the transmission gear are straight teeth, oblique teeth or arc-shaped teeth.

More specifically, a tail section of the spring compressing cavity is provided with a spring seat for positioning the spring.

More specifically, a front side of a last tooth of the upper rack structure of the working piston rod is configured to be separated from the transmission gear when nailing is completed.

More specifically, the transmission structure comprises a driving arm arranged on a lower side of the front end of the vacuum cylinder piston rod, and the driving arm is provided with a first pushing end and a second pushing end which are in secondary transmission with the driving mechanism.

More specifically, a rear end of the driving arm forms the second pushing end directly, a front end of the driving arm extends downward a distance to form the first pushing end, and a level of the first pushing end is lower than that of the second pushing end.

More specifically, the driving arm and the vacuum cylinder piston rod are integrally formed.

More specifically, the driving arm and the vacuum cylinder piston rod are provided individually, and the driving arm is fixed to the vacuum cylinder piston rod through a plurality of screws.

More specifically, the driving mechanism comprises a drive motor, a speed reducer and a crank gear; the drive motor is in direct connection with the speed reducer, the speed reducer is provided with a unidirectionally rotating output shaft, the output shaft is provided with transmission teeth, the crank gear is provided behind the output shaft, and the crank gear is in engaged connection with the transmission teeth; a top surface of the crank gear is provided with a first push bulge and a second push bulge which are arranged at an interval along a circumferential direction, a height of the first push bulge is lower than that of the second push bulge, a position of the first push bulge corresponds to that of the first pushing end, and a position of the second push bulge corresponds to that of the second pushing end; when the crank gear rotates, the first push bulge is configured to firstly abut against the first pushing end and push the first pushing end to drive the vacuum cylinder piston rod to move forward for primary energy storage, and after the primary energy storage, the second push bulge is configured to abut against the second pushing end and push the second pushing end, so that the vacuum cylinder piston rod continues to move forward for secondary energy storage.

More specifically, a mounting base is arranged on a front end of the working piston rod, a connecting platform is formed on a top of the mounting base, a connecting hole is formed in the connecting platform, and a tail section of the gun needle is movably connected with the connecting hole through screws.

According to the high-strength lithium battery nail gun designed in present disclosure, the energy storage structure of the high-strength lithium battery nail gun is a composite structure, and consists of a combination of a spring compressing mechanism and a vacuum cylinder mechanism linked with each other.

During working, the work of the driving mechanism drives the vacuum cylinder piston rod to move forward, and in each forward movement of the vacuum cylinder piston rod, on the one hand, the cylinder piston can be driven to move forward synchronously, so that the vacuum chamber in the cylinder becomes bigger continuously to carry out vacuum energy storage operation, on the other hand, the vacuum cylinder piston rod is moved forward through the engaged transmission of the transmission gear, so that the working piston rod moves backward to further compress the spring for spring energy storage. The above vacuum energy storage and spring compressing energy storage simultaneously constitute power sources for nailing operation of the gun needle. Once the driving mechanism is separated from the vacuum cylinder piston rod, the reset force for compressing the spring acts as a first driving force so that the working piston rod pops out quickly. At the same time, the extended vacuum chamber generates a strong backward adsorption force under the action of atmospheric pressure. The adsorption force quickly drives the cylinder piston and the vacuum cylinder piston rod to move backward, and the backward movement of the vacuum cylinder piston rod forms a second driving force for moving the working piston rod forward through the engaged transmission of the transmission gear, and the above first driving force and second driving force together constitute a driving force of the gun needle. Compared with an independent spring energy storage mechanism, double nailing strength can be obtained, so that the nailing penetrability and nail protruding speed are improved, and the requirement of high-strength nailing can be met.

In addition, the presence of the vacuum cylinder mechanism gives a good cushioning effect to the spring compressing mechanism. After the nailing is completed, the above adsorption force of the vacuum chamber to the cylinder piston still exists, and the second driving force generated by the vacuum chamber always pushes the working piston rod to generate a forward movement trend. The existence of the second driving force effectively offsets the counter-acting force after the spring is impacted in place, and then a good buffering effect is achieved to eliminate the axial and radial vibration of the spring after the nailing is completed, so that the operation comfort of the nail gun is improved, and the fatigue strength of operators is alleviated.

### BRIEF DESCRIPTION OF THE DRAWINGS

To more clearly illustrate the present embodiment of the present disclosure or the technical scheme in the prior art, the following briefly introduces the attached figures to be used in the present embodiment. Apparently, the attached figures in the following description show merely some embodiments of the present disclosure, and those skilled in the art may still derive other drawings from these attached figures without creative efforts.

FIG. 1 is a stereoscopic structural schematic diagram of the present disclosure.

FIG. 2 is a section view of the present disclosure.

FIG. 3 is a section view of the present disclosure during energy storage.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments acquired by the ordinary technical staff in the art under the premise of without contributing creative labor belong to the scope protected by the present disclosure.

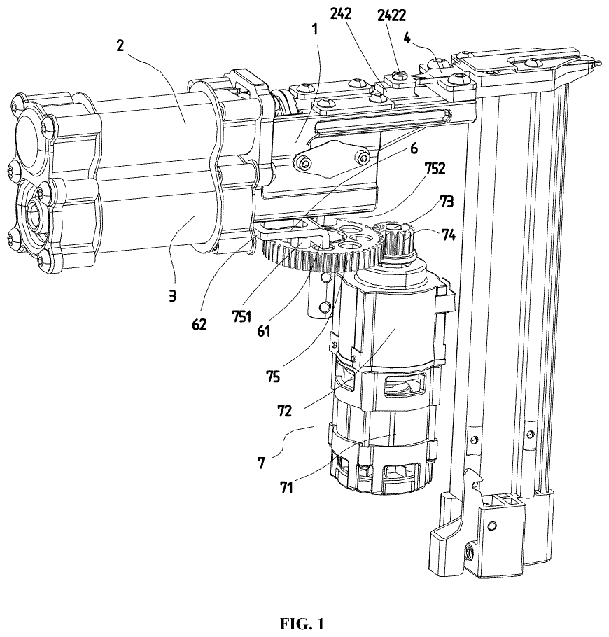

As shown in FIG. 1 to FIG. 3, a high-strength lithium battery nail gun with a composite energy storage structure includes a gun body 1. The tail section of the gun body 1 is provided with an energy storage structure.

The energy storage structure is a composite structure, and includes a spring compressing mechanism 2 and a vacuum cylinder mechanism 3 linked with each other.

Wherein the spring compressing mechanism 2 mainly includes a compression cavity 21, a spring 22, a spring piston 23 and a working piston rod 24.

The spring 22 and the spring piston 23 are mounted in the compression cavity 21 in order. A tail end of the spring 22 abuts against the bottom of the compression cavity 21. A front end of the spring 22 abuts against the spring piston 23 for connection. The spring 22 has a precompression amount in an initial state so that the spring piston 23 always has a forward moving trend.

In order to ensure the centering and effective positioning of the spring 22 in operation, the tail section of the spring compressing cavity 21 is provided with a spring seat 221 for positioning the spring 22.

A front end of the spring piston 23 is connected to the working piston rod 24 for driving a gun needle 4 to work synchronously. A front end of the working piston rod 24 extends out of the compression cavity 21, and the lower part of the working piston rod 24 is provided with an upper rack structure 241.

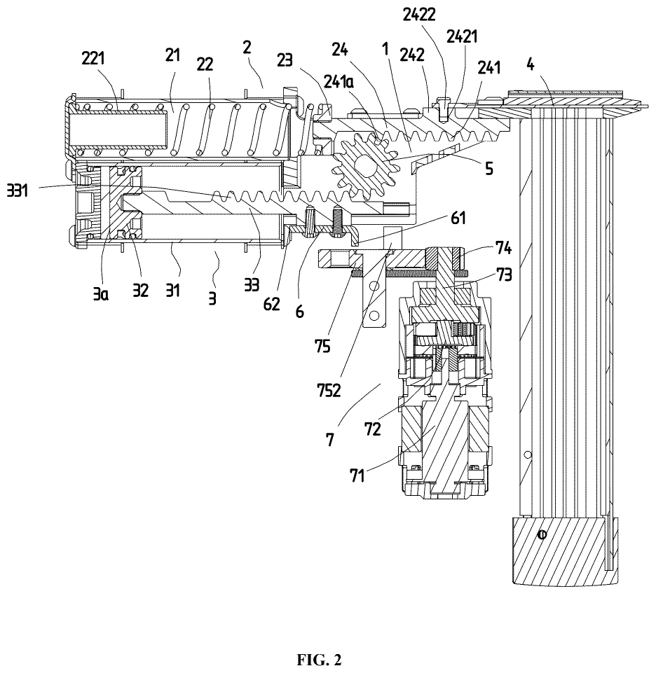

The vacuum cylinder mechanism 3 includes a cylinder 31 and a cylinder piston 32 arranged in the cylinder 31. A completely sealed vacuum chamber 3a is formed by the cylinder piston 32 and a tail end part of the cylinder 31. The cylinder piston 32 is located at the tail section of the cylinder 31 in an initial state, and the structure of the cylinder piston 32 is as shown in FIG. 2.

A front end of the cylinder piston 32 is connected to a vacuum cylinder piston rod 33 extending out of the cylinder 31. The upper side of the vacuum cylinder piston rod 33 is provided with a lower rack structure 331. The lower rack structure 331 is in engaged transmission with the upper rack structure 241 through a transmission gear 5 fixed on the gun body 1.

Here, the teeth of the upper rack structure 241, the transmission gear 5 and the lower rack structure 331 are straight teeth, oblique teeth or arc-shaped teeth. In practice, a corresponding structure is adopted as needed. In practice, other equivalent structures can be selected as long as the engaged transmission of the upper rack structure 241, the transmission gear 5 and the lower rack structure 331 can be realized.

At the same time, a front end of the vacuum cylinder piston rod 33 is provided with a separable transmission structure to be in transmission connection with a driving mechanism 7.

In the embodiment, the transmission structure includes a driving arm 6. The driving arm 6 is provided with a first pushing end 61 and a second pushing end 62 which are in secondary transmission with the driving mechanism 7. A rear end of the driving arm 6 forms the second pushing end 62 directly. A front end of the driving arm 6 extends downward a distance to form the first pushing end 61. The level of the first pushing end 61 is lower than that of the second pushing end 62.

The driving arm 6 and the vacuum cylinder piston rod 33 are integrally formed. However, in practice, for the sake of convenience in processing, the driving arm 6 and the vacuum cylinder piston rod 33 are provided individually in general. The whole driving arm 6 is fixed to the vacuum cylinder piston rod 33 through a plurality of screws. The illustration of the embodiment only describes the split structure.

According to the high-strength lithium battery nail gun designed in the above structure, the energy storage structure of the high-strength lithium battery nail gun is a composite structure, and includes a spring compressing mechanism 2 and a vacuum cylinder mechanism 3 linked with each other.

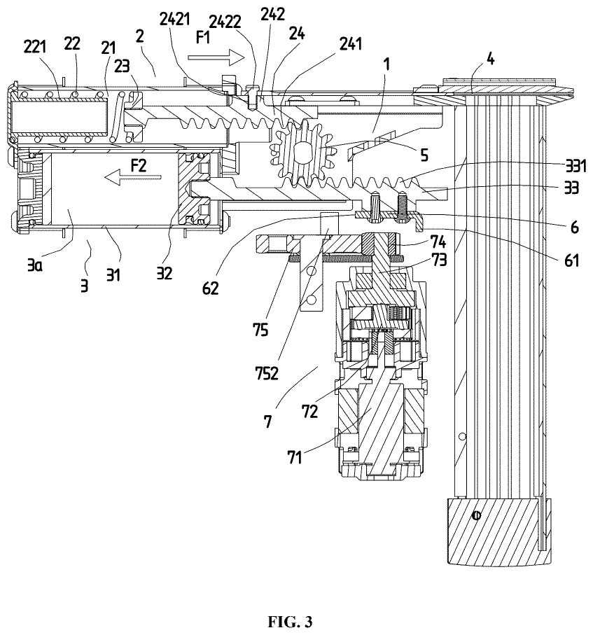

During working, the work of the driving mechanism 7 drives the vacuum cylinder piston rod 33 to move forward to carry out primary energy storage and secondary energy storage sequentially. In each forward movement of the vacuum cylinder piston rod 33, on the one hand, the cylinder piston 32 can be driven to move forward synchronously, so that the vacuum chamber 3a in the cylinder 31 becomes bigger continuously to carry out vacuum energy storage operation, on the other hand, the vacuum cylinder piston rod 33 is moved forward through the engaged transmission of the transmission gear 5, so that the working piston rod 24 moves backward to further compress the spring 22 for spring energy storage, and the structure is as shown in FIG. 3. The above vacuum energy storage and spring energy storage simultaneously constitute power sources for nailing operation of the gun needle 4. Once the driving mechanism 7 is separated from the driving arm 6 on the vacuum cylinder piston rod 33, the reset force for compressing the spring 22 acts as a first driving force F1 so that the working piston rod 24 pops out quickly. At the same time, the vacuum chamber 3a after energy storage generates a strong backward adsorption force F2 to the cylinder piston 32 under the action of atmospheric pressure. The adsorption force F2 quickly drives the cylinder piston 32 and the vacuum cylinder piston rod 33 to move backward, and the backward movement of the vacuum cylinder piston rod 33 forms a second driving force for moving the working piston rod 24 forward through the engaged transmission of the transmission gear 5. The above first driving force and second driving force together constitute a driving force of the gun needle 4. Compared with an independent spring energy storage mechanism, double nailing strength can be obtained within the same distance, so that the nailing penetrability and nail protruding speed are improved, and the requirement of high-strength nailing can be met.

Here, the presence of the vacuum cylinder mechanism 3 gives a good cushioning effect to the spring compressing mechanism 2. After the nailing is completed, the above adsorption force of the vacuum chamber 3a to the cylinder piston 32 still exists due to the influence of atmospheric pressure, and the second driving force generated by the vacuum chamber 3a always pushes the working piston rod 24 to generate a forward movement trend. The existence of the second driving force effectively offsets the backward counter-acting force after the spring 22 is impacted in place, and the axial and radial vibration of the spring 22 is eliminated after the nailing is completed, so that the operation comfort of the nail gun is improved, and the fatigue strength of operators is alleviated.

In addition, at the moment when nailing is completed, the working piston rod 24 still has large forward movement inertia. The inertia force may cause a strong impact force between the upper rack structure 241 and the transmission teeth of the transmission gear 5. The impact force may easily lead to the phenomenon of seizing the upper rack structure 241 and the transmission gear 5 and even the phenomenon of tooth collapse, and then the service lives of the working piston rod 24 and the transmission gear 5 are seriously affected. In order to solve this problem, the front side of the last tooth 241a of the working piston rod 24 and the transmission gear 5 are in a separated state when nailing is completed. At this time, the inertia force of the working piston rod 24 is not transmitted to the transmission gear 5, and then the stress impact between the upper rack structure 241 and the transmission gear 5 is fundamentally eliminated, and the phenomena of seizing and tooth collapse are avoided. However, at the same time, the rear side of the last tooth 241a of the upper rack structure 241 is still in an abutting state with the transmission gear 5, so the axial movement of the working piston rod 24 is still subjected to the limitation of the transmission gear 5 and the vacuum cylinder structure 3, and good vibration buffering and eliminating effects are achieved.

In the embodiment, the driving mechanism 7 mainly includes a drive motor 71, a speed reducer 72 and a crank gear 75. The drive motor 71 is in direct connection with the speed reducer 72. The speed reducer 72 is provided with a unidirectionally rotating output shaft 73. The output shaft 73 is provided with transmission teeth 74. The crank gear 75 is provided behind the output shaft 73. The crank gear 75 is in engaged connection with the transmission teeth 74. A top surface of the crank gear 75 is provided with a first push bulge 751 and a second push bulge 752 which are arranged at an interval along the circumferential direction, wherein the height of the first push bulge 751 is lower than that of the second push bulge 752, the position of the first push bulge 751 corresponds to that of the first pushing end 61, and the position of the second push bulge 752 corresponds to that of the second pushing end 62.

During working, when the drive motor 71 drives the crank gear 73 to rotate, the first push bulge 751 is configured to firstly abut against the first pushing end 61 and push the driving arm 6 to drive the vacuum cylinder piston rod 33 to move forward for primary energy storage. After the primary energy storage, the first push bulge 751 is separated from the first pushing end 61. At the same time, the second push bulge 752 is configured to abut against the second pushing end 62 and further push the driving arm 6, so that the vacuum cylinder piston rod 33 continues to move forward for secondary energy storage. The process is completed until the secondary energy storage. At this time, the second push bulge 752 is separated from the second pushing end 62. At the same time, the first push bulge 751 and the first pushing end 61 are also in a separated state, that is, the restraint of the driving mechanism 7 on the vacuum cylinder piston rod 33 is completely released to enter a nailing working state.

In addition, considering that the gun needle 4 in the nail gun is in a reciprocating high-frequency working state, as a wearing part, the gun needle 4 needs to be replaced frequently in use. Therefore, a mounting base 242 is arranged on the front end of the working piston rod 24. A connecting platform is formed on the top of the mounting base 242. A connecting hole 2421 is formed in the connecting platform. The tail section of the gun needle 4 is movably connected with the connecting hole 2421 through screws 2422. When in use, the replacement operation of the gun needle 4 can be realized just by disassembling the screws 2422, which is convenient and quick.

Above all, the foregoing descriptions are merely exemplary embodiments of the present disclosure, but are not limitation of the present disclosure in any form. Any simple modification, equivalent change, or modification made for the embodiments according to the technical principle of the present disclosure shall fall within the scope of the technical proposal of the present disclosure.

What is claimed is:

1. A high-strength lithium battery nail gun with a composite energy storage structure, comprising a gun body (1) having a tail section of the gun body (1) provided with an energy storage structure, wherein the energy storage structure comprises a spring compressing mechanism (2) and a vacuum cylinder mechanism (3) linked with each other; wherein the spring compressing mechanism (2) comprises a compression cavity (21), a spring (22), a spring piston (23) and a working piston rod (24), the spring (22) and the spring piston (23) are mounted in the compression cavity (21), a tail end of the spring (22) abuts against a bottom of the compression cavity (21), a front end of the spring (22) abuts against the spring piston (23) for connection, and the spring (22) has a precompression amount in an initial state so that the spring piston (23) always has a forward moving trend; a front end of the spring piston (23) is connected to the working piston rod (24) for driving a gun needle (4) to work synchronously, and a lower part of the working piston rod (24) is provided with an upper rack structure (241); the vacuum cylinder mechanism (3) comprises a cylinder (31) and a cylinder piston (32) arranged in the cylinder (31), a completely sealed vacuum chamber (3a) is formed by the cylinder piston (32) and a tail end part of the cylinder (31), the cylinder piston (32) is located at a tail section of the cylinder (31) in an initial state, a front end of the cylinder piston (32) is connected to a vacuum cylinder piston rod (33) extending out of the cylinder (31), an upper side of the vacuum cylinder piston rod (33) is provided with a lower rack structure (331), and the lower rack structure (331) is in engaged transmission with the upper rack structure (241) through a transmission gear (5) fixed on the gun body (1); and a front end of the vacuum cylinder piston rod (33) is provided with a transmission structure to be in transmission connection with a driving mechanism (7).

2. The high-strength lithium battery nail gun with a composite energy storage structure according to claim 1, wherein the lower rack structure (331) is in engaged transmission with the upper rack structure (241) through the transmission gear (5), and teeth of the lower rack structure (331), the upper rack structure (241) and the transmission gear (5) are straight teeth, oblique teeth or arc-shaped teeth.

3. The high-strength lithium battery nail gun with a composite energy storage structure according to claim 1, wherein a tail section of the spring compressing cavity (21) is provided with a spring seat (221) for positioning the spring (22).

4. The high-strength lithium battery nail gun with a composite energy storage structure according to claim 1, wherein a front side of a last tooth (241a) of the upper rack structure (241) of the working piston rod (24) is configured to be separated from the transmission gear (5) when nailing is completed.

5. The high-strength lithium battery nail gun with a composite energy storage structure according to any one of claims 1 to 4, wherein the transmission structure comprises a driving arm (6) arranged on a lower side of the front end of the vacuum cylinder piston rod (33), and the driving arm (6) is provided with a first pushing end (61) and a second pushing end (62) which are in secondary transmission with the driving mechanism (7).

6. The high-strength lithium battery nail gun with a composite energy storage structure according to claim 5, wherein a rear end of the driving arm (6) forms the second pushing end (62) directly, a front end of the driving arm (6) extends downward a distance to form the first pushing end (61), and a level of the first pushing end (61) is lower than that of the second pushing end (62).

7. The high-strength lithium battery nail gun with a composite energy storage structure according to claim 6, wherein the driving arm (6) and the vacuum cylinder piston rod (33) are integrally formed.

8. The high-strength lithium battery nail gun with a composite energy storage structure according to claim 6, wherein the driving arm (6) and the vacuum cylinder piston rod (33) are provided individually, and the driving arm (6) is fixed to the vacuum cylinder piston rod (33) through a plurality of screws.

9. The high-strength lithium battery nail gun with a composite energy storage structure according to claim 6, wherein the driving mechanism (7) comprises a drive motor (71), a speed reducer (72) and a crank gear (75); the drive motor (71) is in direct connection with the speed reducer (72), the speed reducer (72) is provided with a unidirectionally rotating output shaft (73), the output shaft (73) is provided with transmission teeth (74), the crank gear (75) is provided behind the output shaft (73), and the crank gear (75) is in engaged connection with the transmission teeth (74); a top surface of the crank gear (75) is provided with a first push bulge (751) and a second push bulge (752) which are arranged at an interval along a circumferential direction, a height of the first push bulge (751) is lower than that of the second push bulge (752), a position of the first push bulge (751) corresponds to that of the first pushing end (61), and a position of the second push bulge (752) corresponds to that of the second pushing end (62); when the crank gear (75) rotates, the first push bulge (751) is configured to firstly abut against the first pushing end (61) and push the first pushing end (61) to drive the vacuum cylinder piston rod (33) to move forward for primary energy storage, and after the primary energy storage, the second push bulge (753) is configured to abut against the second pushing end (62) and push the second pushing end (62), so that the vacuum cylinder piston rod (33) continues to move forward for secondary energy storage.

10. The high-strength lithium battery nail gun with a composite energy storage structure according to any one of claims 1 to 4, wherein a mounting base (242) is arranged on a front end of the working piston rod (24), a connecting platform is formed on a top of the mounting base (242), a connecting hole (2421) is formed in the connecting platform, and a tail section of the gun needle (4) is movably connected with the connecting hole (2421) through screws (2422).
